(19) United States
(12) Patent Application Publication
(10) Pub. No.: US 2026/0114672 A1
(43) Pub. Date: Apr. 30, 2026

(54) MIXING APPLIANCE INDEXING ASSEMBLY

(71) Applicant: Haier US Appliance Solutions, Inc., Wilmington, DE (US)

(72) Inventors: Alexander Miller, Louisville, KY (US); Tomas Garces, Louisville, KY (US)

(21) Appl. No.: 18/928,281

(22) Filed: Oct. 28, 2024

(51) Int. Cl. A47J 43/044; A23P 30/20; A47J 43/07; A47J 43/08

(52) U.S. Cl. CPC A47J 43/044; A23P 30/20; A47J 43/0727; A47J 43/082; A47J 2043/0449

(57) ABSTRACT

A mixing appliance includes a base and an attachment coupled to the base. The attachment is configured to manipulate food content. Moreover, the mixing appliance includes a drive assembly. The drive assembly includes a motor and a drive shaft. The motor is configured to rotate the drive shaft. Furthermore, the mixing appliance includes an indexing assembly. Moreover, the indexing assembly includes a rotatable member. The rotatable member is coupled to the drive assembly and circumferentially rotatable by the drive assembly. Additionally, the indexing assembly includes a brake member. The brake member is configured to restrict rotation of the rotatable member during contact of the rotatable member by the brake member during the rotation of the rotatable member.

### FIELD OF THE INVENTION

The present disclosure relates generally to mixing appliances, such as stand mixers, or more specifically, to indexing assemblies of mixing appliances.

### BACKGROUND OF THE INVENTION

Stand mixers are generally used for performing automated mixing, churning, or kneading involved in food preparation. Typically, stand mixers include a motor configured to provide torque to one or more drive shafts. Users may connect various utensils or attachments to the one or more drive shafts, including whisks, spatulas, or the like. Generally, the attachments may include one or more devices or mechanisms for manipulating food content, such as a cutting blade for cutting the food content. For example, the cutting blade may be utilized to cut pasta noodles formed by a pasta extruder attachment into pasta noodle pieces. However, oftentimes attachments, such as the cutting blade described above, require manual operation, such as by a user of the stand mixer. For example, the user may be required to manipulate the cutting blade with his/her hands to cut the pasta noodles into pasta noodle pieces. This may be cumbersome and/or take time away from doing other tasks.

Accordingly, an indexing assembly for a mixing appliance would be desirable. More specifically, an indexing assembly for the mixing appliance that limits or prevents manual operation of the indexing assembly by the user of the mixing appliance would be particularly beneficial.

### BRIEF DESCRIPTION OF THE INVENTION

Aspects and advantages of the invention will be set forth in part in the following description, or may be apparent from the description, or may be learned through practice of the invention.

In one example aspect, a stand mixer is provided. The stand mixer defines a vertical direction, a lateral direction, and a transverse direction. The stand mixer includes a base. Additionally, the stand mixer includes a support column. The support column is coupled to the base. Furthermore, the support column extends vertically upward from the base. Moreover, the stand mixer includes a head. The head is coupled to an upper end of the support column. Additionally, the head extends from the support column above the base. Furthermore, the stand mixer includes an attachment. The attachment is coupled to the head. The attachment includes an outlet through which food content exits the attachment. Moreover, the stand mixer includes a drive assembly. The drive assembly includes a motor. Additionally, the drive assembly includes a drive shaft. The motor is configured to rotate the drive shaft. Furthermore, the stand mixer includes an indexing assembly. The indexing assembly defines an axial direction, a radial direction, and a circumferential direction. Moreover, the indexing assembly is coupled to the attachment. The indexing assembly includes a rotatable member. The rotatable member is coupled to the drive assembly, whereby the rotatable member is circumferentially rotatable by the drive assembly. Furthermore, the indexing assembly includes a brake member. The brake member is configured to restrict rotation of the rotatable member during contact of the rotatable member by the brake member during the rotation of the rotatable member.

In another example aspect, a mixing appliance is provided. The mixing appliance includes a base. Additionally, the mixing appliance includes an attachment. The attachment is coupled to the base. Furthermore, the attachment is configured to manipulate food content. Moreover, the mixing appliance includes a drive assembly. The drive assembly includes a motor. Additionally, the drive assembly includes a drive shaft. The motor is configured to rotate the drive shaft. Furthermore, the mixing appliance includes an indexing assembly. The indexing assembly defines an axial direction, a radial direction, and circumferential direction. Moreover, the indexing assembly includes a rotatable member. The rotatable member is coupled to the drive assembly, whereby the rotatable member is circumferentially rotatable by the drive assembly. Additionally, the indexing assembly includes a brake member. The brake member is configured to restrict rotation of the rotatable member during contact of the rotatable member by the brake member during the rotation of the rotatable member.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example embodiment of a stand mixer of the present disclosure.

FIG. 2 provides a perspective view of the example stand mixer of FIG. 1 with an example embodiment of an attachment coupled to the stand mixer.

FIG. 3 provides a perspective view of an example embodiment of an indexing assembly coupled to the example attachment of FIG. 2.

FIG. 4 provides a perspective view of the example indexing assembly of FIG. 3.

FIG. 5 provides a close-up perspective view of the example indexing assembly of FIG. 3.

### DETAILED DESCRIPTION OF THE INVENTION

Reference now will be made in detail to embodiments of the invention, one or more examples of which are illustrated in the drawings. The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations may be made in the present invention without departing from the scope of the invention. For instance, features illustrated or described as part of one embodiment may be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

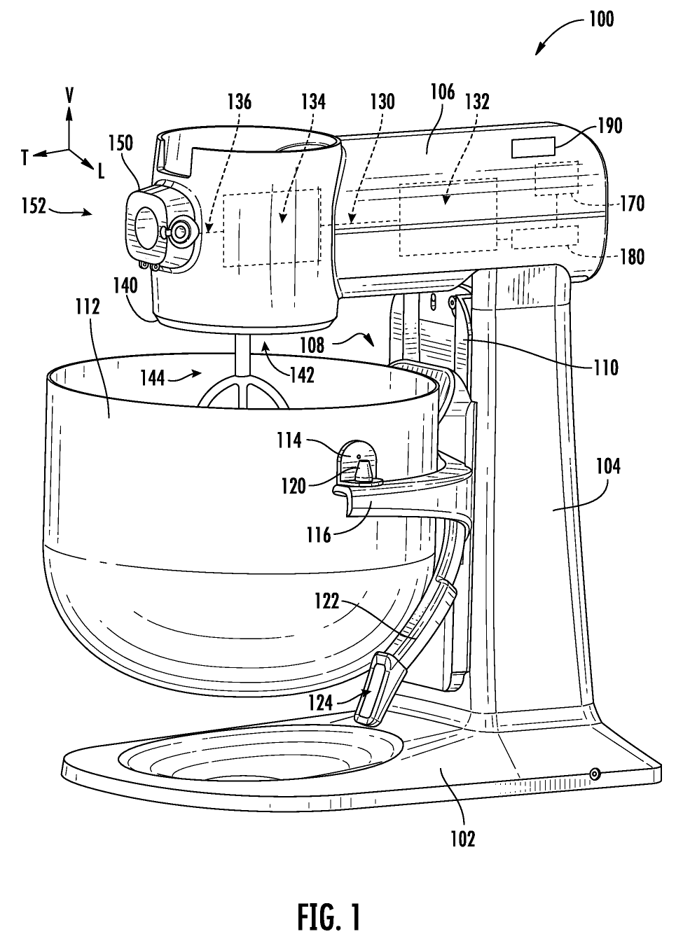

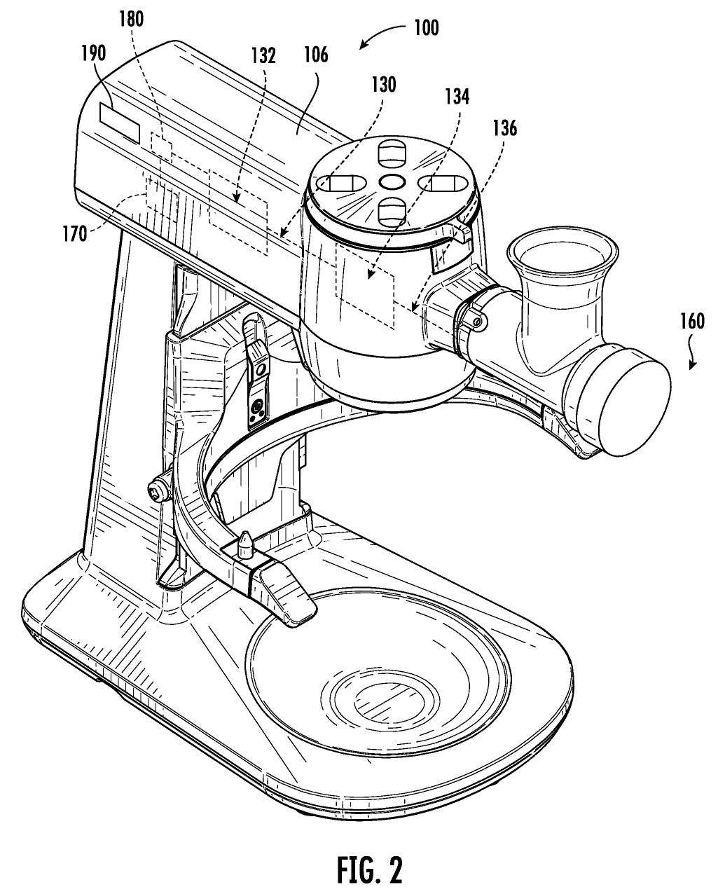

Referring to the figures, FIGS. 1 and 2 provide perspective views of a mixing appliance according to an example embodiment of the present subject matter. As shown in FIGS. 1 and 2 and as described herein, the mixing appliance is configured as a stand mixer 100. However, it will be appreciated that stand mixer 100 is provided by way of example only and that the present subject matter may be used in or with any suitable mixing appliance, such as a hand mixer, an immersion blender, a countertop blender, and/or the like, in alternative example embodiments. Moreover, with reference to each of FIGS. 1 and 2, stand mixer 100 may define a vertical direction V, a lateral direction L, and a transverse direction T, which are mutually perpendicular and form an orthogonal direction system. It should be understood that these directions are presented for example purposes only, and that relative positions and locations of certain aspects of stand mixer 100 may vary according to specific embodiments, spatial placement, or the like.

As shown, stand mixer 100 includes a base 102 and may include a support post or column 104. The column 104 may include a bowl support 108. The bowl support 108 may slidably mount to a column rail 110, which is mounted to column 104. Additionally, components of bowl support 108 may extend outwardly above base 102, e.g., in the transverse direction T, and may hold bowl 112 above base 102, e.g., along the vertical direction V. The bowl 112 may be removably mounted on bowl support 108 via flanges 114. The flanges 114 may be on opposite sides of the bowl 112 with respect to the circumference of the bowl.

Additionally, as best illustrated in FIG. 1, bowl support 108 may include an arm 116 with a mounting spike 120. The arm 116 may hold bowl 112 via mounting spike 120, which may removably couple to flanges 114. For instance, each mounting spike 120 on arm 116 may be received within a respective flange 114 on bowl 112. One or more lift levers 122, such as two lift levers 122, may rotatably couple to arm 116. Thus, bowl 112 may be disposed between lift levers 122, e.g., along the lateral direction L. Each lift lever 122 may be positioned on a respective side of bowl 112, such that both a left-handed user and a right-handed user may comfortably operate lift levers 122. Each of the lift levers 122 may have one end, a distal end 124, cantilevered from support column 104. The distal end 124 may correspond to a handle for a user to grasp, push, or pull.

Furthermore, support column 104 may support a mixer head 106, which is positioned atop column 104. For example, as shown in FIG. 1, head 106 may be mounted to column 104, which is mounted to base 102. Thus, column 104 may extend between and connect base 102 and head 106, e.g., along the vertical direction V. The head 106 may extend outwardly above the base 102, e.g., in the transverse direction T. Furthermore, mixer head 106 may house a drive assembly 130 of stand mixer 100. The drive assembly 130 may include a motor 132, a gearbox 134, and/or a drive shaft 136. The motor 132 may be configured to rotate drive shaft 136 bi-directionally, or in a first rotational or circumferential direction (e.g., clockwise rotation) and a second rotational or circumferential direction (e.g., counterclockwise rotation) different from the first rotational direction. The structure and operation of drive components, e.g., motor, gearbox, and drive shaft, are understood by those of ordinary skill in the art. As such, these components are illustrated diagrammatically and are not discussed in comprehensive details herein for the sake of brevity and clarity.

Furthermore, head 106 may include a mixing attachment support 140. The mixing attachment support 140 may be located on a lower portion or underside 142 of head 106 and forward of support column 104 along transverse direction T. A rotating mixing attachment 144 may be removably coupled to the mixing attachment support 140. Additionally, drive shaft 136 may connect motor 132 with gearbox 134 and mixing attachment support 140 such that motor 132 may drive rotation of mixing attachment 144 when mixing attachment 144 is coupled to mixing attachment support 140. Furthermore, gearbox 134 may allow user selection of different rotating speeds for mixing attachment 144. The stand mixer 100 may include one or more controls for operations such as selectively powering motor 132, choosing the speed of rotation for mixing attachment 144, choosing the direction of rotation for mixing attachment 144, and/or other features. In certain embodiments, mixing attachment support 140 may accept more than one type of mixing attachment 144. Various types of mixing attachments may be used including e.g., whisks, paddles, dough hooks, beaters, and others for purposes of mixing ingredients within a bowl or other container supported by the base 102. During use, mixing attachment 144 may be rotated in a circular or planetary manner. Rotation in a planetary manner, as used herein, includes rotating both in a circular manner and rotating about an axis that moves in a circular manner.

An example operation of an exemplary embodiment of stand mixer 100 of the present disclosure is described below. In the operation of stand mixer 100, a user may load food items into bowl 112. The food items may be ingredients, such as flour, water, milk, etc. These items are provided for example purposes only and one skilled in the art would appreciate that there are many more types of food items that may be placed in bowl 112 of stand mixer 100. After loading the food items into bowl 112, a user may turn on stand mixer 100 to begin the process of mixing, kneading, beating, etc. The motor 132 rotates an attachment, such as mixing attachment 144, attached to stand mixer 100 to complete each of these processes.

Moreover, head 106 includes an auxiliary attachment support 150 located on a forward portion or frontside 152 of head 106 in the transverse direction T and forward of support column 104 in the transverse direction T. An auxiliary attachment (FIG. 2), such as a pasta extruder attachment 160, may be removably coupled to auxiliary attachment support 150. For example, a removable pin (not shown) may couple pasta extruder attachment 160 to auxiliary attachment support 150. The drive shaft 136 may connect motor 132 with gearbox 134 and auxiliary attachment support 150 such that motor 132 may drive rotation of various components of the pasta extruder attachment 160 when pasta extruder attachment 160 is coupled to auxiliary attachment support 150. In certain embodiments, auxiliary attachment support 150 may accept more than one type of auxiliary attachment. For example, various types of auxiliary attachments may be used for the purpose of molding or forming dough into molded shapes or otherwise processing food.

Furthermore, one or more sensors 170 may be provided in operative association with stand mixer 100. The sensor(s) 170 is configured to measure or generate data indicative of an operational parameter associated with rotation of drive assembly 130. For example, as will be described below, a torque may be applied to motor 132 by an indexing assembly of stand mixer 100. In some embodiments, sensor(s) 170 may be configured to generate data indicative of the torque applied to motor 132. For example, sensor(s) 170 may be configured as a torque transducer or other torque sensing device. Additionally, or alternatively, in some embodiments, sensor(s) 170 may be configured to generate data indicative of a rotational speed of motor 132 and/or drive shaft 134 of drive assembly 130. For example, sensor(s) 170 may be configured as an optical sensor and/or the like. Additionally, or alternatively, in some embodiments, sensor(s) 170 may be configured to generate data indicative of a rotational or circumferential direction, e.g., clockwise direction and/or counterclockwise direction, of motor 132 and/or drive shaft 134 of drive assembly 130. For example, sensor(s) 170 may be configured as an optical sensor and/or the like. A controller, such as controller 180 described below, may utilize the data generated by sensor(s) 170 to control the operation of stand mixer 100.

The stand mixer 100 may further include a controller 180. Operation of stand mixer 100 is regulated by controller 180 that is operatively coupled to a control panel 190. In some exemplary embodiments, control panel 190 may represent a general purpose I/O ("GPIO") device or functional block. In some exemplary embodiments, control panel 190 may include input components, such as one or more of a variety of electrical, mechanical or electro-mechanical input devices including rotary dials, push buttons, touch pads, and touch screens. The control panel 190 may be communicatively coupled with controller 180 via one or more signal lines or shared communication busses. The control panel 190 provides selections for user manipulation of the operation of stand mixer 100, e.g., whereby a user may provide one or more rotational speeds at which drive assembly 130 of stand mixer 100 may operate. In response to user manipulation of the control panel 190, controller 180 operates various components of stand mixer 100. For example, controller 180 is operatively coupled or in communication with motor 132. The controller 180 may also be operatively coupled or in communication with one or more sensors such as, for example, sensor(s) 170. The controller 180 may receive signals or data from these sensor(s) 170 that are indicative of the operational parameter(s) associated with rotation of drive assembly 130 as described above. Furthermore, control panel 190 may be configured to provide feedback from controller 180 to the user of stand mixer 100. As such, control panel 190 may include one or more feedback devices (not shown), which are configured to provide feedback from the controller 180 to the user.

The controller 180 includes memory and one or more processing devices such as microprocessors, CPUs or the like, such as general or special purpose microprocessors operable to execute programming instructions or micro-control code associated with operation of stand mixer 100. The memory may represent random access memory such as DRAM, or read only memory such as ROM or FLASH. The processor executes programming instructions stored in the memory. The memory may be a separate component from the processor or may be included onboard within the processor. Alternatively, controller 180 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. The controller 180 may be positioned in a variety of locations throughout stand mixer 100.

The controller 180 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices may store information and/or data accessible by the one or more processors, including instructions that may be executed by the one or more processors. It should be appreciated that the instructions may be software written in any suitable programming language or may be implemented in hardware. Additionally, or alternatively, the instructions may be executed logically and/or virtually using separate threads on one or more processors.

For example, controller 180 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 180 as disclosed herein is capable of and may be operable to perform any methods, method steps, or portions of methods as disclosed herein. For example, in some embodiments, methods disclosed herein may be embodied in programming instructions stored in the memory and executed by controller 180.

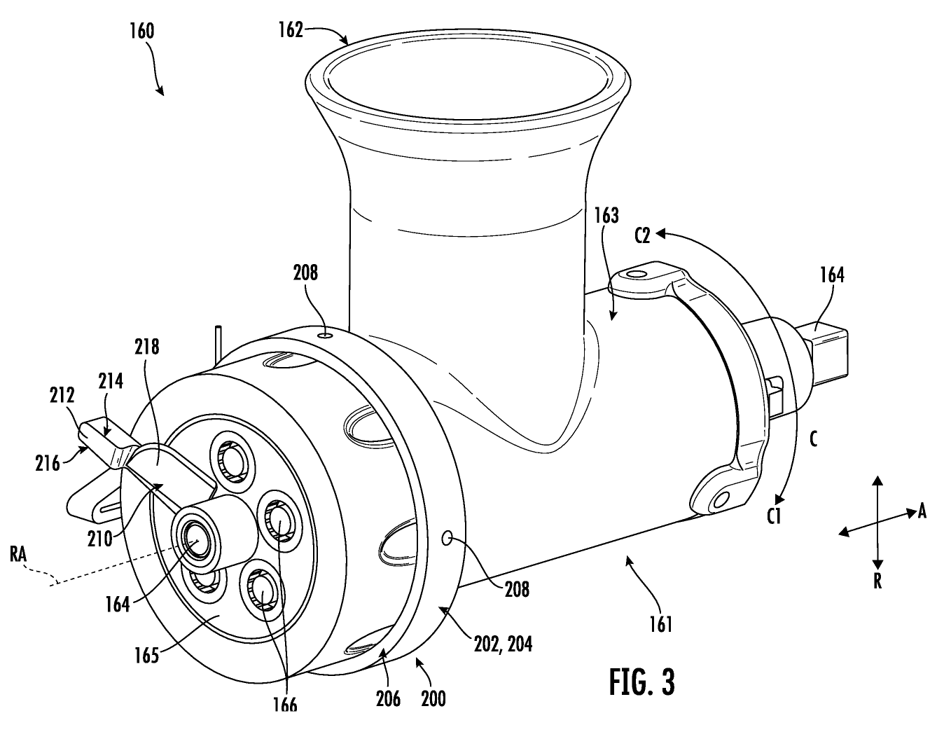

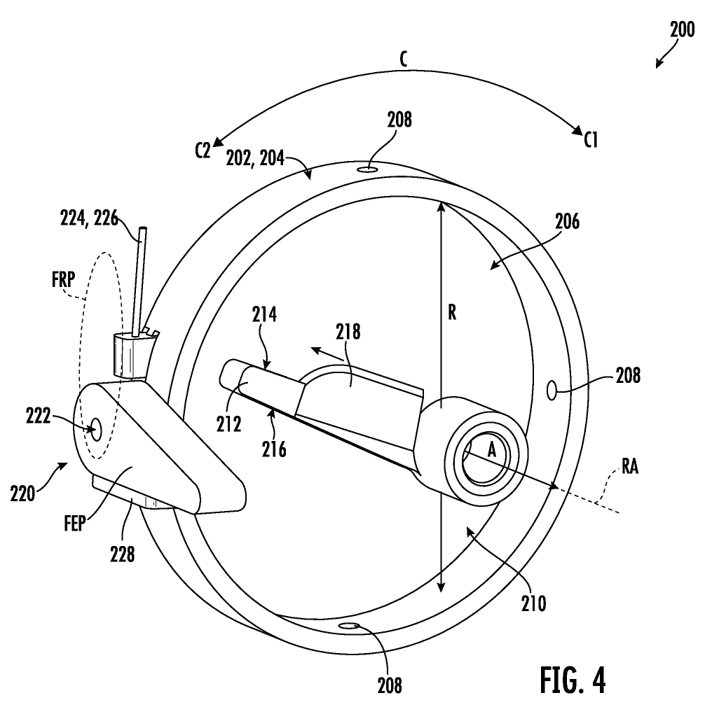

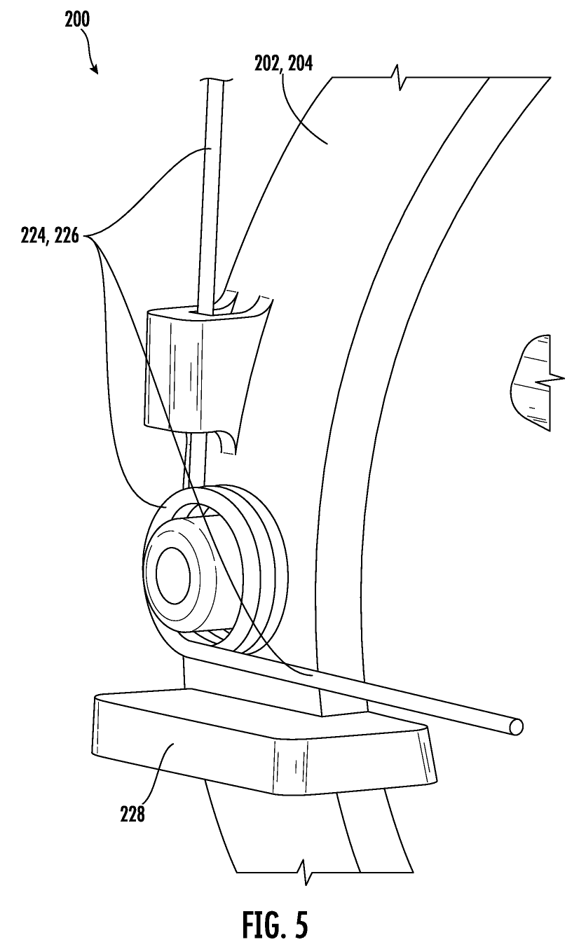

Referring now to FIGS. 3 through 5, differing views of an example indexing assembly 200 to be utilized with a mixing appliance, such as stand mixer 100, are provided. Specifically, FIG. 3 provides a perspective view of indexing assembly 200 coupled to an auxiliary attachment, such as pasta extruder attachment 160. FIG. 4 provides a perspective view of indexing assembly 200 in isolation, i.e., not coupled to an auxiliary attachment. FIG. 5 provides a close-up perspective view of indexing assembly 200 with brake member 220 of indexing assembly 200 omitted for illustrative purposes. The indexing assembly 200 generally defines a radial direction R, an axial direction A, and a circumferential direction C such that a cylindrical coordinate system is generally defined. The term “radial” refers to the relative direction that is substantially perpendicular to an axial centerline of indexing assembly 200. The term “axially” refers to the relative direction that is substantially parallel and/or coaxially aligned to an axial centerline of indexing assembly 200. The term “circumferentially” refers to the relative direction that extends around the axial centerline of indexing assembly 200. Although indexing assembly 200 is described herein as being used with stand mixer 100 and with pasta extruder attachment 160, it should be appreciated that indexing assembly 200 may be used on any other suitable mixing appliance, e.g., such as a hand mixer, an immersion blender, and/or the like, and/or any other suitable attachment, e.g., such as a food slicer attachment, a food grinder attachment, and/or the like. Although an exemplary construction of indexing assembly 200 is described herein, it should be appreciated that variations and modifications may be made to indexing assembly 200 while remaining within the scope of the present subject matter.

According to example embodiments, indexing assembly 200 may be utilized with an auxiliary attachment of stand mixer 100, such as pasta extruder attachment 160. As best illustrated in FIG. 3, pasta extruder attachment 160 may include a housing 161. The housing 161 may house various internal components of pasta extruder attachment 160, some or all of which may be utilized to manipulate food content, e.g., dough. As such, housing 161 may include an inlet component, such as hopper 162 shown in FIG. 3. The hopper 162 may extend from a main housing body 163. The food content may be received through hopper 162 within main housing body 163 to be manipulated by various internal components of pasta extruder attachment 160. For example, the food content may be conveyed through main housing body 163 by a conveyor component (not shown), such as an auger (not shown), which may be positioned within main housing body 163. The auger may be coupled to a drive shaft extension 164 of pasta extruder attachment 160, which may be coupled to drive shaft 136 of drive assembly 130 of stand mixer 100 when pasta extruder attachment 160 is coupled to stand mixer 100. In this respect, drive shaft extension 164 and, thus, the auger, may be rotatable by drive assembly 130 of stand mixer 100.

Additionally, pasta extruder attachment 160 may include an outlet component, such as a mold cover 165 (FIG. 3). One or more mold openings 166 may be defined through the mold cover 165 through which the food content exits pasta extruder attachment 160. As such, the conveyor component, such as the auger described above, may apply force to the food content, e.g., dough, to push the dough through the mold opening(s) 166. As the dough is pushed through the mold opening(s) 166, the mold opening(s) 166 form the dough pushed through the mold opening(s) 166 into shapes, such as pasta noodle shapes.

According to example embodiments, indexing assembly 200 may include a frame 202. The frame 202 may be utilized to mount at least a portion of indexing assembly 200 to pasta extruder attachment 160 or other auxiliary attachment. For example, as best illustrated in FIGS. 3 and 4, frame 202 may be configured as a mounting ring 204. The mounting ring 204 may define a mounting ring opening 206 through which a portion of pasta extruder attachment 160, such as main housing body 163 and/or mold cover 165, may be received. Additionally, one or more fastener holes 208 may be defined through mounting ring 204 for receiving a fastener(s), e.g., set screw(s), for fastening or securing mounting ring 204 to pasta extruder attachment 160. Additionally, as will be described below, one or more other components of indexing assembly 200 may be mounted to frame 202/mounting ring 204.

According to example embodiments, indexing assembly 200 may include a rotatable member 210. As will be described below, rotatable member 210 may be utilized collectively with a brake member to apply a torque to motor 132 of drive assembly 130 of stand mixer 100. Additionally, or alternatively, in some embodiments, rotatable member 210 may be utilized to manipulate the food content, such as by cutting pasta noodles formed by pasta extruder attachment 160 into pasta noodle pieces as the pasta noodles exit pasta extruder attachment 160.

According to example embodiments, rotatable member 210 may be rotatable about an axis of rotation RA, such as about a first circumferential direction C1 and a second circumferential direction C2 opposite the first circumferential direction C1. In this respect, rotatable member 210 may be coupled to drive assembly 130. For example, rotatable member 210 may include an arm portion 212. The arm portion 212 may be fixedly coupled to drive shaft extension 164, such as externally of pasta extruder attachment 160. In this respect, drive shaft extension 164 may extend through and externally of mold cover 165 as shown in FIG. 3. As motor 132 rotates drive shaft 136/drive shaft extension 164 rotatable member 210 rotates with drive shaft 136/drive shaft extension 164. Furthermore, as described above, motor 132 may be configured to rotate drive shaft 136 and, thus, drive shaft extension 164, bi-directionally, such as in the first circumferential direction C1, e.g., clockwise, and the second circumferential direction C2, e.g., counterclockwise. In this respect, rotatable member 210 may also be bi-directionally rotatable in the first and second circumferential directions C1, C2 by the drive shaft extension 164. Additionally, arm portion 212 may define a leading edge 214 and a trailing edge 216 spaced apart from leading edge 214. During rotation of rotatable member 210 and, thus, rotation of arm portion 212, in one direction, e.g., the first circumferential direction C1, leading edge 214 may be positioned ahead of trailing edge 216. Likewise, during rotation of rotatable member 210 in a different direction, e.g., the second circumferential direction C2, trailing edge 216 may be positioned ahead of leading edge 214.

According to example embodiments, rotatable member 210 may include a cutting blade portion 218. As best illustrated in FIG. 4, cutting blade portion 218 may be fixedly mounted or attached to arm portion 212. In this respect, cutting blade portion 218 rotates with arm portion 212. However, while rotatable member 210 is described herein as having a separate arm portion 212 and cutting blade portion 218, it should be appreciated that, in some embodiments, rotatable member 210 may only include cutting blade portion 218 which also corresponds to the arm portion 212. The cutting blade portion 218 may be utilized to cut or sever food content exiting pasta extruder attachment 160. For example, as rotatable member 210 is rotated by drive assembly 130, cutting blade portion 218 may sever or cut the formed pasta noodles exiting pasta extruder attachment 160 into pasta noodle pieces.

According to example embodiments, indexing assembly 200 may include a brake member 220. In some embodiments, brake member 220 may be coupled to/mounted on mounting ring 204, such as at a pivot joint 222. As best illustrated in FIG. 4, brake member 220 may be rotatable about pivot joint 222 between a plurality of positions ranging from a fully retracted position FRP to a fully extended position FEP. In some embodiments, the range of rotation of brake member 220 may be ninety degrees or approximately ninety degrees. Additionally, when brake member 220 is in the fully extended position FEP, brake member 220 may extend from mounting ring 204 in axial direction A such that brake member 220 is positioned within a rotational path of rotatable member 210. In this respect, as will be described below, brake member 220 may be physically contacted by rotatable member 210, such as during the rotation of rotatable member 210. Likewise, when brake member is in the fully retracted position FRP, brake member 220 may extend from mounting ring 204 in radial direction R such that brake member 220 is positioned outside of the rotational path of rotatable member 210. In this respect, brake member 220 may not be physically contacted by rotatable member 210. As illustrated in FIGS. 3 and 4, brake member 220 may be configured as a “bumper” or “flipper.” However, it should be appreciated that brake member 220 may be configured as any suitable brake member.

According to example embodiments, indexing assembly 200 may include a biasing element 224. The biasing element 224 may be coupled between mounting ring 204 and brake member 220. The biasing element 224 may apply a force to brake member 222 to bias brake member in the fully extended position FEP. In this respect, the force applied by biasing element 224 to brake member 220 may be overcome to rotate brake member 220 away from fully extended position FEP and toward fully retracted position FRP. As best illustrated in FIG. 5, biasing element 224 may be configured as a torsion spring 226. However, it should be appreciated that, in other embodiments, biasing element 224 may be configured as any suitable type of biasing element.

According to example embodiments, brake member 220 may be configured to restrict the rotation of rotatable member 210 in at least one direction during physical contact of rotatable member 210 by brake member 220 during the rotation of rotatable member 210. As such, in some embodiments, indexing assembly 200 may include a brake member stopping component, such as stop plate 228, for preventing brake member 220 from being rotated by rotatable member 210. As best illustrated in FIGS. 4 and 5, stop plate 228 may protrude or extend from mounting ring 204, such as below brake member 220 in the axial direction A. In this respect, stop plate 228 may be positioned within a rotational path of rotational member 220. As such, stop plate 228 restricts brake member 220 from being rotated, such as rotated beyond the fully extended position FEP, by rotatable member 210 during the rotation of rotatable member 210, such as during rotation of rotatable member 210 in the second circumferential direction C2.

According to example embodiments, rotatable member 210 may physically contact brake member 220 during the rotation of rotatable member 210 while brake member 220 is in the fully extended position FEP. For example, during rotation of rotatable member 210 in the first circumferential direction C1, leading edge 214 of rotatable member 210 may physically contact brake member 220. The biasing element 224 may bias brake member 220 against rotation toward the fully retracted position FRP by rotatable member 210. In this respect, the resistive force applied by brake member 220 on rotatable member 210 may create an applied torque to motor 132 of drive assembly. Data indicative of the applied torque to motor 132 may be generated by sensor(s) 170 and utilized by controller 180, such as to control the operation of motor 132 to change the rotational direction, the rotational speed, and/or the like of rotatable member 210. However, brake member 220 may be rotated away from fully extended position FEP by rotatable member 210 during the rotation of rotatable member 210 in the first circumferential direction C1. In some embodiments, rotatable member 210 may apply sufficient force to briefly brake member 220 to move brake member 220 out of the rotational path of rotational member 210. In this respect, rotational member 210 may continue the rotation in the first circumferential direction C1 without a change in the rotational direction of the rotational member 210. Additionally, during rotation of rotatable member 210 in the second circumferential direction C2, trailing edge 216 of rotatable member 210 may physically contact brake member 220. The stop plate 228 may restrict/prevent brake member 220 from rotating beyond the fully extended position FEP by rotatable member 210. In this respect, the resistive force applied by brake member 220 on rotatable member 210 may create an applied torque to motor 132 of drive assembly. Data indicative of the applied torque to motor 132 may be generated by sensor(s) 170 and utilized by controller 180 in the ways described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A stand mixer defining a vertical direction, a lateral direction, and a transverse direction, the stand mixer comprising:
a base;
a support column coupled to the base and extending vertically upward from the base;
a head coupled to an upper end of the support column and extending from the support column above the base;
an attachment coupled to the head, the attachment comprising an outlet through which food content exits the attachment;
a drive assembly including a motor and a drive shaft, the motor configured to rotate the drive shaft; and
an indexing assembly defining an axial direction, a radial direction, and a circumferential direction, the indexing assembly coupled to the attachment, the indexing assembly comprising:
a rotatable member coupled to the drive assembly, whereby the rotatable member is circumferentially rotatable by the drive assembly; and
a brake member, the brake member configured to restrict rotation of the rotatable member during contact of the rotatable member by the brake member during the rotation of the rotatable member.

2. The stand mixer of claim 1, wherein:
the rotatable member is rotatable by the drive assembly in a first circumferential direction and a second circumferential direction opposite from the first circumferential direction; and
the brake member is configured to restrict the rotation of the rotatable member in the second circumferential direction during contact of the rotatable member by the brake member during the rotation of the rotatable member.

3. The stand mixer of claim 1, wherein:
the brake member is rotatable about a pivot joint between a plurality of positions from a fully extended position in which the rotatable member contacts the brake member during the rotation of the rotatable member and a fully retracted position in which the rotatable member does not contact the brake member during the rotation of the rotatable member.

4. The stand mixer of claim 3, wherein:
the rotatable member defines a leading edge for contacting the brake member during the rotation of the rotatable member in a first circumferential direction, thereby rotating the brake member away from the fully extended position; and
the rotatable member defines a trailing edge for contacting the brake member during the rotation of the rotatable member in a second circumferential direction opposite from the first circumferential direction.

5. The stand mixer of claim 4, wherein:
the indexing assembly further comprises a brake member stop plate protruding from the frame of the indexing assembly and positioned within a rotational path of the brake member; and
the stop plate restricts the brake member from being rotated beyond the fully extended position by the rotatable member during rotation of the rotatable member in the second circumferential direction.

6. The stand mixer of claim 1, the rotatable member of the indexing assembly comprising an arm portion and a cutting blade portion fixedly coupled to the arm portion, whereby the cutting blade portion cuts the food content exiting the attachment of the stand mixer during the rotation of the rotatable member.

7. The stand mixer of claim 1, the indexing assembly further comprising a biasing element for biasing the brake member, thereby inhibiting the rotation of the rotatable member during contact of the brake member by the rotatable member.

8. The stand mixer of claim 7, wherein the biasing element is configured as a torsion spring.

9. The stand mixer of claim 1, further comprising a controller configured to control an operation of the motor in response to the brake member restricting the rotation of the rotatable member.

10. The stand mixer of claim 1, wherein the brake member of the indexing assembly is coupled to a mounting ring through which the attachment of the stand mixer is received to mount at least a portion of the indexing assembly onto the attachment.

11. A mixing appliance, comprising:
a base;
an attachment coupled to the base, the attachment configured to manipulate food content;
a drive assembly including a motor and a drive shaft, the motor configured to rotate the drive shaft; and
an indexing assembly defining an axial direction, a radial direction, and a circumferential direction, the indexing assembly comprising:
a rotatable member coupled to the drive assembly, whereby the rotatable member is circumferentially rotatable by the drive assembly; and
a brake member, the brake member configured to restrict rotation of the rotatable member during contact of the rotatable member by the brake member during the rotation of the rotatable member.

12. The mixing appliance of claim 11, wherein:
the rotatable member is rotatable by the drive assembly in a first circumferential direction and a second circumferential direction different from the first circumferential direction; and
the brake member is configured to restrict the rotation of the rotatable member in the second circumferential direction during contact of the rotatable member by the brake member during the rotation of the rotatable member.

13. The mixing appliance of claim 11, wherein:
the brake member is rotatable about a pivot joint between a plurality of positions from a fully extended position in which the rotatable member contacts the brake member during the rotation of the rotatable member and a fully retracted position in which the rotatable member does not contact the brake member during the rotation of the rotatable member.

14. The mixing appliance of claim 13, wherein:
the rotatable member defines a leading edge for contacting the brake member during the rotation of the rotatable member in a first circumferential direction, thereby rotating the brake member away from the fully extended position; and
the rotatable member defines a trailing edge for contacting the brake member during the rotation of the rotatable member in a second circumferential direction different from the first circumferential direction.

15. The mixing appliance of claim 14, wherein:
the indexing assembly further comprises a brake member stop plate protruding from the frame of the indexing assembly and positioned within a rotational path of the brake member; and
the stop plate restricts the brake member from being rotated beyond the fully extended position by the rotatable member during rotation of the rotatable member in the second circumferential direction.

16. The mixing appliance of claim 11, the rotatable member of the indexing assembly comprising an arm portion and a cutting blade portion fixedly coupled to the arm portion, whereby the cutting blade portion cuts the food content during the rotation of the rotatable member.

17. The mixing appliance of claim 11, the indexing assembly further comprising a biasing element for biasing the brake member, thereby inhibiting the rotation of the rotatable member during contact of the brake member by the rotatable member.

18. The mixing appliance of claim 17, wherein the biasing element is configured as a torsion spring.

19. The mixing appliance of claim 11, wherein the brake member of the indexing assembly is coupled to a mounting ring through which the attachment of the mixing appliance is received to mount at least a portion of the indexing assembly onto the attachment.
